(19) United States
(12) Patent Application Publication
(10) Pub. No.: US 2005/0053199 A1
(43) Pub. Date: Mar. 10, 2005

(54) Portable x-ray device and method

(76) Inventor: Dale A. Miles, Fountain Hills, AK (US)

Correspondence Address: Denise M Gosnell Esq;Woodard Emhardt Moriarty McNett & Henry LLP, Bank One Center/Tower, 111 Monument Circle Suite 3700, Indianapolis, IN, 46204-5137, US

(21) Appl. No.: 10/655,521

(22) Filed: Sep. 4, 2003

(51) Int. Cl. H05G 1/02

(52) U.S. Cl. 378/197

(57) ABSTRACT

A portable and preferably hand-held X-ray generator for use in intraoral and other X-ray applications, and a new process of dental image acquisition which utilizes a PDA device to set exposure factors and fire the x-ray device. An articulating arm and cradle allows one generator to be used in multiple operatories. The system's generator has a reduced X-ray output and much smaller focal spot area than conventional dental X-ray generators, which reduces the X-ray output and the overall patient X-ray burden. The smaller focal spot also allows for improved resolution in the final image.

### TECHNICAL FIELD OF THE INVENTION

The present invention relates generally to X-ray devices and, more particularly, to portable X-ray devices.

### BACKGROUND OF THE INVENTION

For decades, medical professionals, such as dentists, have routinely used X-ray radiographs for disease detection, diagnostic decision making and treatment monitoring. X-rays are emitted by an X-ray generator, pass through the structures of interest such as teeth, bone and soft tissues of the head and jaws, and are captured by an appropriate receptor. The traditional receptor, X-ray photographic film, is still the most widely used. In such film-based systems, the latent image is produced on the film through activation of silver halide crystals which are then rendered visible by processing the exposed film in chemical solutions. Such film processing takes several minutes when a series of X-ray films are exposed on the patient. If, after developing, the images are discovered to be unusable due to film placement or image geometry errors, a new series of films need to be exposed. This increases the patient X-ray dose.

Recently, systems have been introduced for electronic acquisition of dental X-ray information through the use of charge coupled device (CCD) image receptors. Current CCD receptors for oral, intraoral and maxillofacial imaging tasks use either radiation-hardened CCD arrays (Regam SensAray, Sundvaal, Sweden) or CCD arrays coupled to a scintillator such as a rare-earth X-ray screen material (Trophy Radiologie, Vincennes, France). The largest area array currently used in dental imaging is now approximately 760 pixels by 524 pixels (Schick Technologies, New York), which results in a resolution of about 10 line pairs/mm.

Imaging with a CCD receptor requires approximately 70-80% less exposure time than imaging with X-ray film. Thus, the patient X-ray dose is lessened. However, most current X-ray generators were designed for use with film receptors; consequently, they produce too much X-ray radiation, overloading the CCD receptor and increasing the patient absorbed X-ray dose.

Another problem with current X-ray generators is that they are large and heavy, thereby requiring that they be installed in a fixed location. For dental applications, the X-ray generator is typically fixedly mounted to the distal end of an articulating arm which is in turn mounted to the wall of the dental operatory. The weight of the tubehead often requires the placement of additional support in the wall where the unit is mounted in order to support the tubehead at its maximum length from the wall. Because a dental office normally includes several operatories, the provision of X-ray imaging capability to each of the operatories requires a substantial investment since multiple X-ray units much be purchased.

There is, therefore, a need for an X-ray device that will lessen the patient X-ray dose. There is also a need for an X-ray device that can easily be used in several different operatories in order to reduce duplication of equipment within the dental office. The present invention is directed toward meeting these needs.

### SUMMARY OF THE INVENTION

The present invention relates to a portable and preferably hand-held X-ray generator for use in intraoral and other X-ray applications, and a new process of dental image acquisition which utilizes a PDA device to set exposure factors and fire the X-ray device. An articulating arm and cradle allows one generator to be used in multiple operatories. The system's generator has a reduced X-ray output and much smaller focal spot area than conventional dental X-ray generators, which reduces the X-ray output and the overall patient X-ray burden. The smaller focal spot also allows for improved resolution in the final image.

In one embodiment of the present invention, a method for generating an X-ray image is disclosed comprising providing a portable X-ray device; providing a PDA device for selecting X-ray options; transmitting a begin signal from the PDA device to the portable X-ray device; and capturing an image on an image receptor upon receiving X-rays emitted by the X-ray device.

In another embodiment of the present invention, a method for generating an X-ray image is disclosed comprising providing a portable X-ray device; providing a PDA device for selecting X-ray options; selecting one or more operational parameters on the PDA; transmitting a begin signal from the PDA device to the portable X-ray device, said begin signal based on the selected one or more operational parameters; and capturing an image on an image receptor upon receiving X-rays emitted by the X-ray device.

In yet another embodiment of the present invention, a method for generating an X-ray image is disclosed comprising a) providing a portable X-ray device, comprising an enclosure; an X-ray tube mounted within the enclosure; a collimated tube mounted to the enclosure and positioned such that X-rays will be emitted into the collimated tube when the X-ray tube is activated; wiring extending between an interior of the enclosure and operative to couple an external power supply to the X-ray tube; power supply circuitry operative to generate a voltage to drive the X-ray tube, wherein the power supply circuitry is not contained within the enclosure and is coupled to the enclosure by the wiring; control circuitry operative to control an exposure time of the X-ray tube, wherein the control circuitry is not contained within the enclosure and is coupled to the enclosure by the wiring; a receiver coupled to the power supply and control circuitry, said receiver operable to receive wireless signals; b) providing an articulating arm having a connector thereon, adapted to couple the X-ray device to the articulating arm; c) coupling the X-ray device to the articulating arm; d) aiming the collimated tube at an X-ray image receptor; e) moving the articulated arm such that a structure to be imaged is positioned between the collimated tube and the receptor; f) providing a PDA device having a display, said PDA device operable for wireless transmission of an enable signal and an exposure signal; and selecting at least one option from the display of the PDA device, thereby causing the enable signal and the exposure signal to be wirelessly transmitted to the receiver.

In yet another embodiment of the present invention, a portable X-ray device is disclosed comprising an enclosure; an X-ray tube mounted within the enclosure; a collimated tube mounted to the enclosure and positioned such that X-rays will be emitted into the collimated tube when the X-ray tube is activated; wiring extending between an interior of the enclosure and operative to couple an external power supply to the X-ray tube; power supply circuitry operative to generate a voltage to drive the X-ray tube, wherein the power supply circuitry is not contained within the enclosure and is coupled to the enclosure by the wiring; control circuitry operative to control an exposure time of the X-ray tube, wherein the control circuitry is not contained within the enclosure and is coupled to the enclosure by the wiring; a receiver coupled to the power supply and control circuitry, said receiver operable to receive wireless signals; and a PDA device operable to wirelessly transmit an enable signal and an exposure signal to the receiver.

In another embodiment of the present invention, an X-ray device is disclosed, comprising an X-ray tube; a collimated tube positioned such that X-rays will be emitted into the collimated tube when the X-ray receives a begin signal from a PDA device; a slot formed through a surface of the collimated tube; and a filter removably inserted through the slot, such that an X-ray beam passing through the collimated tube will also pass through the filter.

### BRIEF DESCRIPTION OF THE DRAWINGS

FIG. 1 is a schematic side cross-sectional view of a first embodiment portable X-ray generator of the present invention.

FIG. 2 is a schematic circuit diagram of a power supply circuit of the present invention.

FIG. 3 is a schematic circuit diagram of a timing and control circuit of the present invention.

FIG. 4 is a schematic circuit diagram of an X-ray generator driving circuitry of the present invention.

FIG. 5 is a side elevational view of a first embodiment receptor holder of the present invention.

FIG. 6 is a first end elevational view of the receptor holder of FIG. 5.

FIG. 7 is a second end elevational view of the receptor holder of FIG. 5.

FIG. 8 is a side elevational view of a second embodiment receptor holder of the present invention.

FIG. 9 is a cross-sectional view of the receptor holder of FIG. 8.

FIG. 10 is a side elevational view of the portable X-ray generator of the present invention making an X-ray image of a maxillary tooth.

FIG. 11 is a side elevational view of the portable X-ray generator of the present invention making an X-ray image of a mandibular tooth.

FIG. 12 is a perspective view of a dental operatory including the portable X-ray device of the present invention.

FIG. 13 is a schematic cross-sectional view of a second embodiment portable X-ray generator of the present invention.

FIG. 14 is a perspective view of an X-ray collimated tube and drop-in filter of the present invention.

FIG. 15 is a side cross-sectional view of a third embodiment receptor holder of the present invention making an X-ray image of a maxillary tooth.

FIG. 16 is a perspective view of a proximal end of the receptor holder of FIG. 16.

FIG. 17 is a partial side elevational view of a fourth embodiment receptor holder of the present invention.

FIG. 18 is a front end elevational view of a third embodiment portable X-ray generator of the present invention.

FIG. 19 is a side elevational view of the third embodiment portable X-ray generator of FIG. 18.

FIG. 20 is a side elevational view of a fourth embodiment portable X-ray generator of the present invention, having a collimated tube with an integrated CCD receptor adaptor.

FIG. 21 is a side elevational view of a collimated tube adapted for use with the fourth embodiment portable X-ray generator of FIG. 20 and having an X-ray film receptor.

FIG. 22 is a top plan view of the fourth embodiment portable X-ray generator of FIG. 20.

FIG. 23 is a front elevational view of the fourth embodiment portable X-ray generator of FIG. 20.

FIG. 24 is a rear elevational view of the fourth embodiment portable X-ray generator of FIG. 20, mounted to an articulated arm.

FIG. 25 is a perspective view of a second embodiment dental operatory including the fourth embodiment portable X-ray generator of the present invention.

FIG. 26 is a front elevational view of a display window for use with the fourth embodiment portable X-ray generator of the present invention.

FIG. 27 is a top plan view of the fourth embodiment portable X-ray generator of the present invention, showing the attachment location of the display window of FIG. 26.

FIG. 28 is a side elevational view of the fourth embodiment portable X-ray generator of the present invention, showing the attachment location of the display window of FIG. 26.

FIG. 29 is a rear elevational view of the fourth embodiment portable X-ray generator of the present invention, showing the display window of FIG. 26 attached thereto.

FIG. 30A is a schematic diagram of a first half of a preferred embodiment method of controlling a portable X-ray device using a PDA.

FIG. 30B is a schematic diagram of a second half of a preferred embodiment method of controlling a portable X-ray device using a PDA.

FIG. 31 is a simulated screen of a preferred embodiment showing how the user begins the process of using a PDA to control the portable X-ray device.

FIG. 32 is a simulated screen of a preferred embodiment showing how the user selects a patient type on a PDA.

FIG. 33 is a simulated screen of a preferred embodiment showing how the user selects an image receptor type on a PDA.

FIG. 34 is a simulated screen of a preferred embodiment showing how the user selects an area to X-ray from a PDA.

FIG. 35 is a simulated screen of a preferred embodiment showing how the system displays the selected options and allows the user to fire a portable X-ray device from a PDA.

FIG. 36 is a simulated screen of a preferred embodiment showing how the system displays on a PDA an image captured by the portable X-ray device.

### DETAILED DESCRIPTION OF SELECTED EMBODIMENTS

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

The present invention relates to a portable and preferably hand-held X-ray generator for use in intraoral and other X-ray applications, and a new process of dental image acquisition which utilizes a PDA device to set exposure factors and fire the X-ray device. An articulating arm and cradle allows one generator to be used in multiple operatories. The system's generator has a reduced X-ray output and much smaller focal spot area than conventional dental X-ray generators, which reduces the X-ray output and the overall patient X-ray burden. The smaller focal spot also allows for improved resolution in the final image.

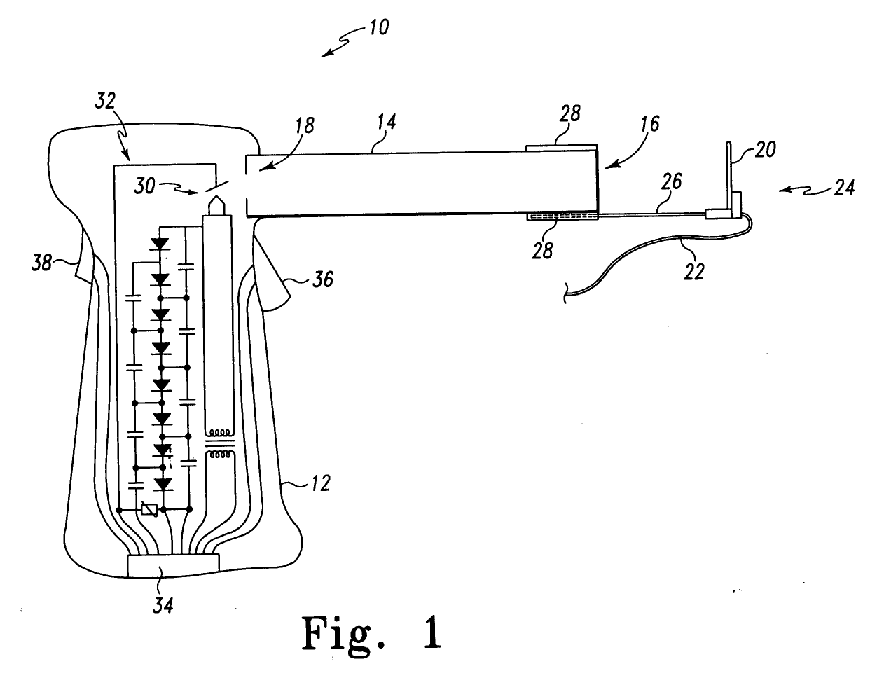

Referring to FIG. 1, one embodiment of the portable X-ray generator of the present invention is illustrated and indicated generally at 10. The X-ray generator 10 is illustrated in cross-sectional view in FIG. 1 and includes a “pistol grip” handle 12 to which is attached a rectangular collimated tube 14. The handle 12 and tube 14 are preferably formed from LITHARCH lead ceramic material or from a lead-lined, high density plastic. The distal opening 16 of the collimated tube 14 is preferably 2.5 centimeters by 3.0 centimeters. The size of the distal opening 16 is preferably sized to be just slightly larger than the receptor size to be used with the X-ray generator 10. The proximal end of the tube 14 includes a rectangular, aluminum collimated tube which has an aperture (port or exit) of approximately 3 millimeters by 5 millimeters.

An X-ray receptor 20 is provided for recording the X-ray image. The X-ray receptor 20 may be any device which is sensitive to X-ray radiation, such as X -ray film or a CCD sensor. The receptor 20 is illustrated as a CCD sensor in FIG. 1, including the wiring 22 which is used to couple the CCD receptor 20 to a recording and display device as is known in the art. The CCD receptor 20 is positioned in a receptor holder 24 which is coupled to a rod 26 which is adapted to fit within any one of a plurality of docking slots 28 formed on the distal end of the collimated tube 14. The design and operation of the receptor holder 24 and docking slots 28 is discussed in greater detail hereinbelow.

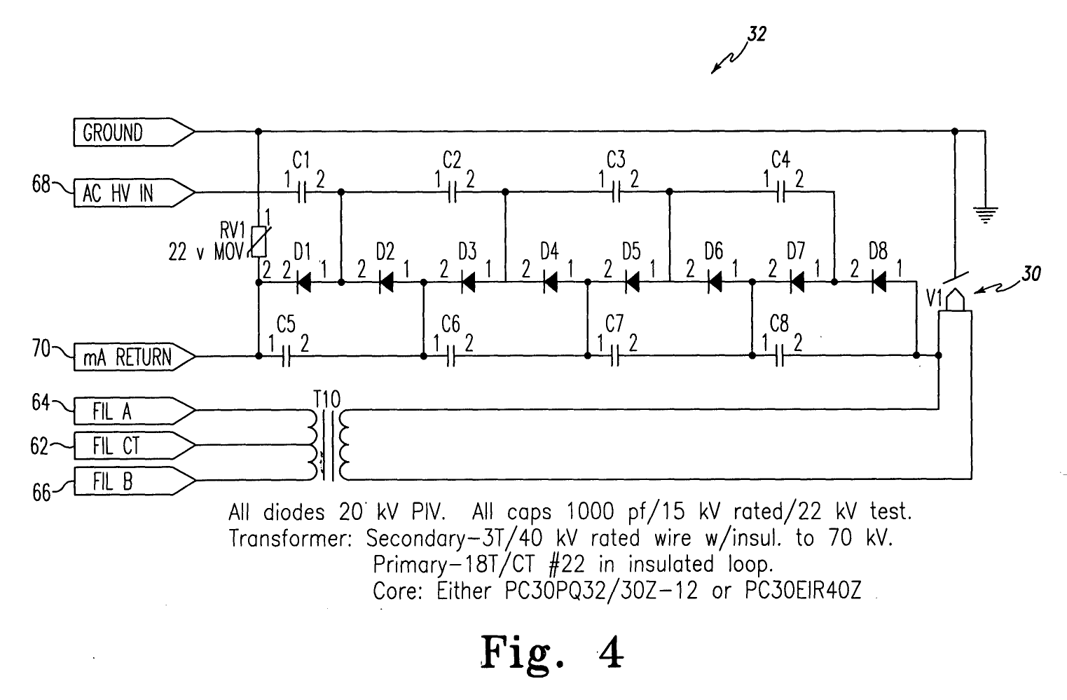

The handle 12 of the X-ray generator 10 includes an X-ray tube 30 and associated driving circuitry 32. The X-ray tube 30 and driving circuitry 32 are described in greater detail hereinbelow with respect to FIG. 4. Because it is desired that the present invention comprise a portable and preferably hand-held X-ray generator, the isolation transformer normally used in X-ray generators has been eliminated in the present invention. Furthermore, the high voltage transformer is not placed within the handle 12, but is remote from the X-ray generator 10 and the high voltage signal is wired from the high voltage transformer to the circuitry 32 within the handle 12, as explained in greater detail hereinbelow. The handle 12 is filled with oil or preferably gas in order to dissipate heat generated by the X-ray tube 30, as is known in the art. The distance from the collimated tube 18 to the distal end 16 of the collimated tube 14 is preferably 15 centimeters.

The rectangular, collimated tube 14 is much smaller than the conventional round cone used in almost every prior art dental X-ray tubehead. The diameter of the prior art round cone is approximately 2.75″, whereas the tube 14 dimensions are preferably only 2.0″×1.5″. This smaller size is possible because the receptor is uniquely fixed to the generator. This arrangement leads to smaller skin surface X-ray dose and to a potential X-ray dose reduction by eliminating retakes of films because of vertical or horizontal angulation errors which occur frequently when a free-floating conventional tubehead is aimed at the film by the operator. In addition the preferred 0.3 mm focal spot is ½ the size of the smallest focal spot presently available in the prior art devices.

The various input and output connections of the circuitry 32 are coupled to an electrical connector 34 mounted in the base of the handle 12. These connections are described in greater detail hereinbelow. Also coupled to the connector 34 are an enable switch 36 and a fire switch 38. The enable switch 36 is preferably located on the handle 12 at a position where it will be convenient to be depressed by the index finger of the user. As described in greater detail hereinbelow, the enable switch 36 initiates current flow to warm up the X-ray tube 30 prior to actual firing of the X-ray generator 10. After the enable switch 36 has been depressed, the operator depresses the fire switch 38 in order to activate the X-ray generator 10. The fire switch 38 is preferably located on the handle 12 at a position which is conveniently accessed by the operator's thumb. The two switch configuration should act as a safeguard against inadvertent firing of the unit and is described in greater detail hereinbelow. Those skilled in the art will appreciate that the wiring within the handle 12 may be hard-wired to the external circuitry rather than using the electrical connector 34.

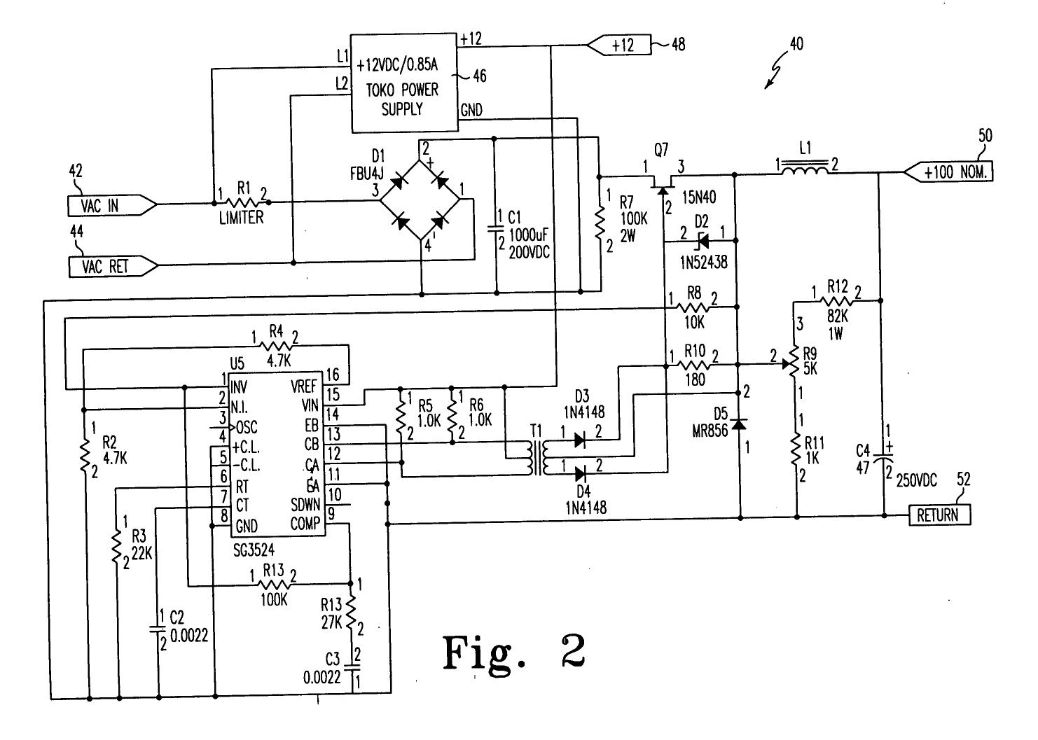

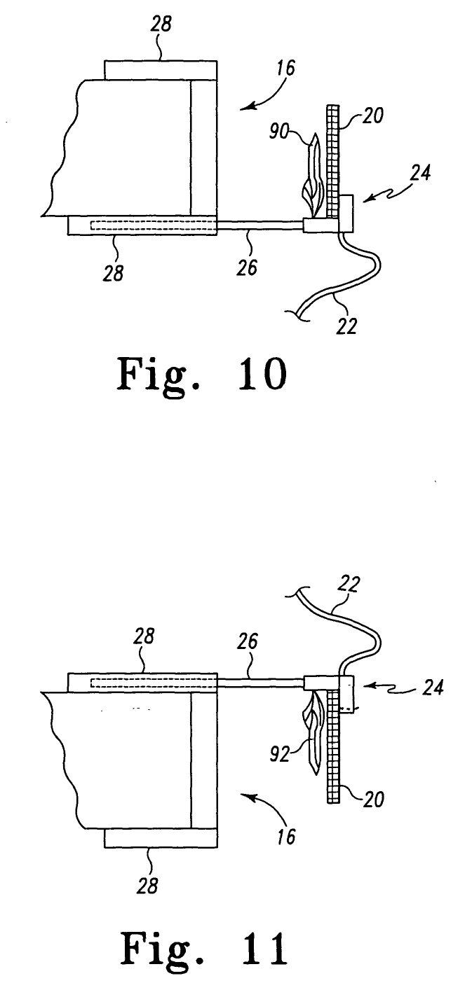

Referring now to FIG. 2, a power supply circuit for the hand-held X-ray generator of the present invention is illustrated, and indicated generally at 40. The power supply circuit 40 is preferably not contained within the handle 12 in order to reduce the weight thereof. Instead the power supply circuit 40 is contained in a separate housing and is coupled to the handle 12 via cabling (see FIG. 10). The circuit 40 is coupled to a standard 110 volt power line at inputs 42 and 44. The 110 volt inputs 42 and 44 are coupled to a 12 volt regulator 46 in order to produce the 12 volt output 48, as is known in the art. The power line inputs 42 and 44 are further coupled to a full wave rectifier D1. The output ports of the full wave rectifier D1 are placed across the 1,000 uF capacitor C1. The voltage placed across the capacitor C1 is typically 160 volts DC. A switching regulator controller chip U5 (such as a SG3524) produces two control outputs CA and CB which are coupled to the transformer T1. The transformer T1 preferably has a 120 turn center tapped primary and an 84 turn center tapped secondary. The transformer T1 combines the two control signals into a single signal feeding a series power field effect transistor (FET) Q7.

The duty cycle of the power FET Q7 determines the output voltage presented at output ports 50 and 52. The switching regulator U5 feeds current to a series inductor L1 and that current (i) increases at a rate determined by the voltage difference (v) across the inductor L1 and the inductance (L) according to the formula:
v=Ldi/dt.
After a few microseconds, the FET Q7 is switched off and the inductance L causes the input voltage of the inductor L1 to switch rapidly to ground, where it is caught by the clamp diode D5, at which point the current starts to ramp down according to the following formula:
v′=−Ldi/dt
(where v′ is the output voltage appearing across the terminals 50 and 52).

The ratio of the on and off times determines the output voltage and the switching regulator U5 controls this. The switching regulator is very efficient, and generates very little heat and the parts for the power supply circuit 40 are small and inexpensive. It will be appreciated by those skilled in the art that the circuit 40 is essentially tied to the power line at the inputs 42 and 44, with only the rectifier D1 for isolation. The present invention, therefore, eliminates the isolation transformer normally used in such systems in order to keep the system small and light weight. The output voltage appearing across the terminals 50 and 52 is nominally +100 VDC, but may be set anywhere between. +40 and +120 VDC in order to set the X-ray tube 30 anode voltage between 20 and 80 kVp.

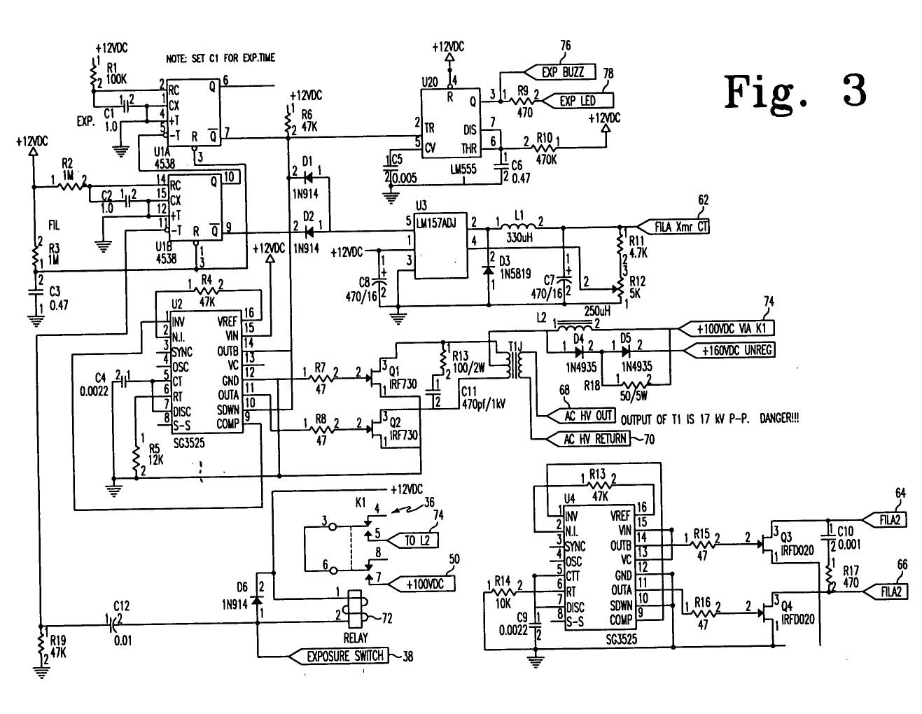

Referring now to FIG. 3, a control circuit of the present invention is illustrated and indicated generally at 60. The control circuit 60 is preferably mounted in the same housing as the power supply circuit 40 (see FIG. 10). The control circuit 60 uses a dual monostable multivibrator U1A and U1B (preferably a 4538) in order to generate two timing signals: the filament pre-heat signal and the exposure time signal. A short negative pulse to pin 11 of U1B causes pin 9 of U1B to switch from +12V to ground for 1.0 second and then return to +12V. The output signal on pin 9 of U1B is coupled through the diode D2 to the adjustable switching regulator U3 (preferably a LM1575adj, manufactured by National Semiconductor), as an enable signal. The switching regulator U3 produces an output voltage which is applied to output port 62 and is adjustable from +2V to +11V. The output port 62 is coupled to the center cap of the filament transformer T10 of FIG. 4.

The circuit of U4, Q3 and Q4 comprise a square wave power generator which is coupled to the filament transformer T10 of FIG. 4 via the output ports 64 and 66. Adjustment of the variable resistor R12 (coupled to U3) will set the filament voltage, and thus the X-ray generator tube 30 anode current. This filament current is on whenever U3 is enabled.

When the 1.0 second time interval ends, pin 10 of U1B feeds a signal to pin 5 of U1A in order to generate the exposure gate at pin 7 of U1A. The exposure gate signal feeds another diode D1 in order to enable U3 so that the filament circuit is energized for the sum of the pre-heat time (1.0 second) and the exposure time, whatever the exposure time may be. The exposure time is determined by the product of R1 and C1 at the input of U1A. A 0.1 second exposure time is indicated by the values of FIG. 3. However, R1 and C1 may be changed by a simple switching circuit so that variable exposure times can be selected by the operator. The resistance and capacitance values made available to the operator by such a switching circuit would be determined by the desired application for the X-ray generator. In a preferred embodiment, exposure times of 0.04, 0.06, 0.08, 0.10, 0.15, 0.20, 0.30, 0.40, 0.50 and 0.60 seconds are provided.

The exposure gate signal at pin 7 of U1A is also sent as an enable signal to U2 (preferably a SG3525), which is used as a low impedance square wave generator feeding two power FET's, Q1 and Q2. These two power FET's feed the high voltage transformer T11. The output of the high voltage transformer T11 is coupled to the output ports 68 and 70, which feed the voltage multiplier in the X-ray generator handle 12 (see FIGS. 1 and 4).

The circuit coupled to the ports 68 and 70 has a relatively large distributed capacitance which is coupled through the secondary of T11 to the primary of T11 as a relatively large capacitance. When the circuit switches from Q1 to Q2 or back to Q1, this capacitance makes the primary circuit of T11 look like a short circuit until that capacitance has been charged. A current limiting circuit of some type must therefore be used in order for the circuit to operate properly. In the present invention, the inductor L2 is used as a limiting inductor. When the capacitance is fully charged, the sudden change of current is limited by the inductor L2 and energy which is stored is released via the diode D4 into a small load resistor R18. If the X-ray generator tube 30 should happen to arc, higher voltage transients are limited by the diode D5 to the raw +160 VDC signal, which is sufficient to let transient signals dissipate their energy without damaging the FET's Q1 and Q2. Those skilled in the art will recognize that the circuit 60 relies on the insulation of transformer T11 and the insulation of filament transformer T10 (see FIG. 4) in order to prevent any connection between the user and the power line voltage.

A relaxation oscillator U20 (preferably a LM555) is also connected to the exposure gate signal provided by pin 7 of U1A. At the start of the gate, U20 will activate its output at pin 3 and energize a small beeper and an LED in order to indicate the exposure. The on time of U20 is approximately 0.5 seconds, enough to be seen and heard even when the actual exposure time is less than 0.01 seconds.

Federal safety rules and common sense require a “dead-man” switch to be incorporated into the control circuitry for an X-ray generator. This means that the operator's exposure switch 38 will not permit X-ray emission from the X-ray generator tube 30 unless the dead-man enable switch 36 is also currently depressed. This is accomplished with a common relay 72 having contacts wired in series with the +100 VDC line. The enable switch 34 couples the +100 VDC voltage to the inductor L2 via the port 74.

Referring now to FIG. 4, the circuitry 32 located within the handle 12 of the portable X-ray generator is illustrated in greater detail. The high voltage circuit 32 operates at 25 kHz and incorporates a voltage 10-tupler. The filament circuit also operates at 25 kHz and the transformer T10 secondary comprises just three turns of insulated wire. The size and weight of the high voltage circuitry 32 are relatively low in order to allow the portable X-ray generator 10 of FIG. 1 to be easily handled by the operator. The filament transformer T10 utilizes a small ferrite core in order to further reduce the system weight.

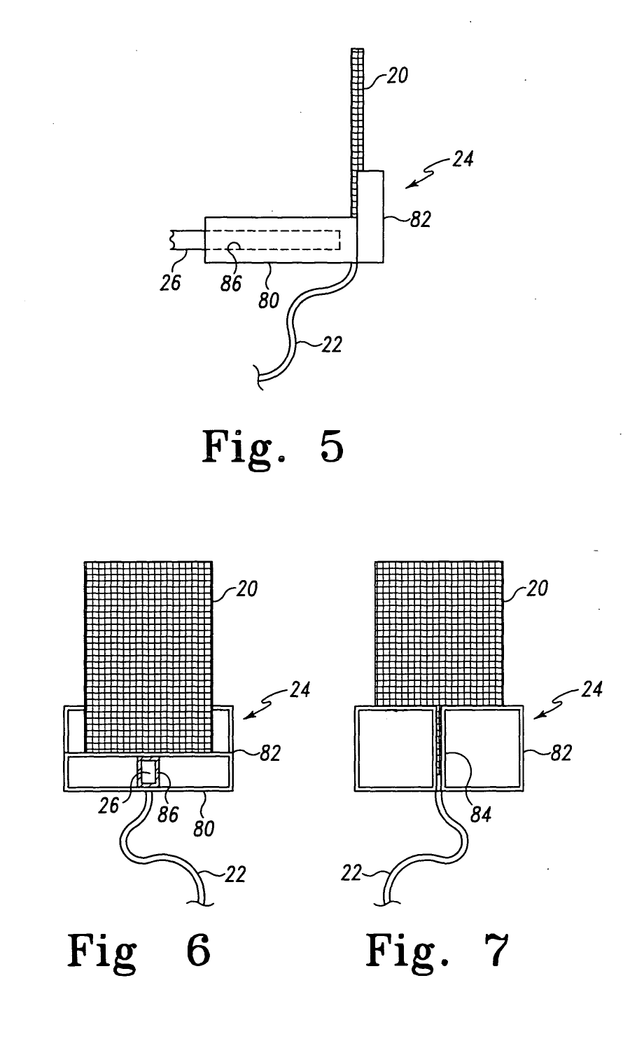

Referring now to FIGS. 5-7, a first embodiment of the X-ray receptor holder 24 is illustrated. The holder 24 comprises a horizontal portion 80 and an attached vertical portion 82. The X-ray receptor 20 fits securely within a recess formed at the junction between the members 80 and 82 as illustrated. A slot 84 is formed in the vertical member 82 in order to accommodate the wiring 22 which is used to control the X-ray receptor 20 and to download information therefrom when the receptor 20 is a CCD device. The horizontal member 80 includes a longitudinal slot 86 therein in order to mount the positioning bar 26 which engages the docking slots 28 of the X-ray tube 14. The use of the receptor holder 24 mounted to the positioning bar 26 will automatically create perfect parallelism between the sensor 20 and the portable X-ray generator 10, thus eliminating beam alignment problems due to erroneous vertical and horizontal angulations. In other words, the sensor 20 will always be perpendicular to the X-ray beam. This will reduce the patient's absorbed X-ray burden due to angulation errors, by eliminating retakes of poorly aligned receptors 20. Furthermore, the holder 24 and beam alignment arm 26 are detachable from the portable X-ray generator 10 and therefore may be autoclaved for later reuse.

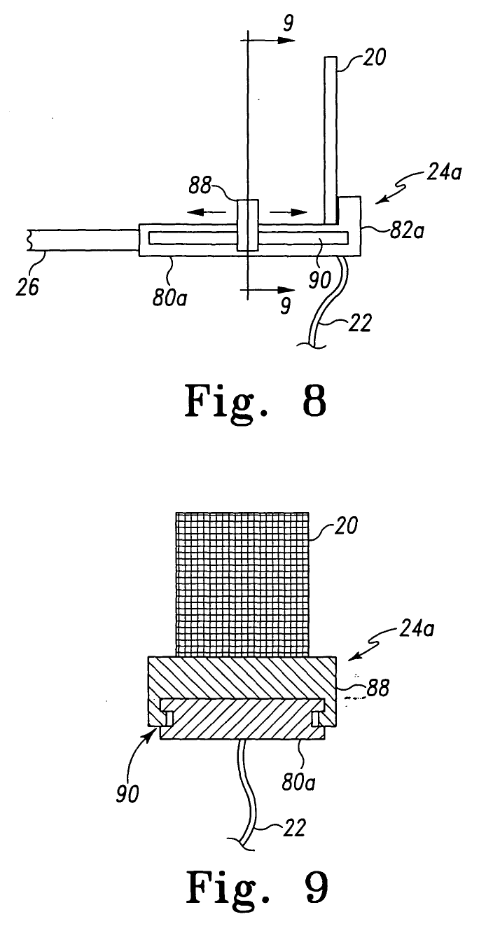

A second embodiment receptor holder is illustrated in FIGS. 8-9, and indicated generally at 24a. The holder 24a comprises a horizontal portion 80a and an attached vertical portion 82a. The horizontal member 80a includes a longitudinal slot (not shown) therein in order to mount the positioning bar 26 which engages the docking slots 28 of the X-ray tube 14. The X-ray receptor 20 may be placed at the junction between the members 80a and 82a as illustrated.

A slot (not shown) is formed in the vertical member 82a in order to accommodate the wiring 22 which is used to control the X-ray receptor 20 and to download information therefrom when the receptor 20 is a CCD device. The receptor 20 is held in place by means of a sliding bar 88 which rides within the track 90 formed on either side of the horizontal member 80a. The sliding bar 88 allows the receptor holder 24 to be used with X-ray receptors 20 having any thickness. Because CCD receptors vary in thickness, and all are much thicker than X-ray film, the receptor holder 24a will accommodate any size receptor.

Referring now to FIG. 10, use of the portable X-ray generator 10 in a dental application is illustrated, specifically with making an X-ray radiograph of a maxillary tooth 90. In this arrangement, the beam alignment arm 26 is placed in the lower docking slot 28 of the X-ray tube 14. This allows the receptor 20 and receptor holder 24 to be positioned within the patient's mouth and extend upwards behind the maxillary tooth 90. The corresponding positioning is shown in FIG. 11 for use of the portable X-ray device 10 with a mandibular tooth 92. In this orientation, the beam alignment arm is inserted into the upper docking slot 28 of the X-ray tube 14 so that the X-ray receptor 20 extends in a downward direction behind the mandibular tooth 92.

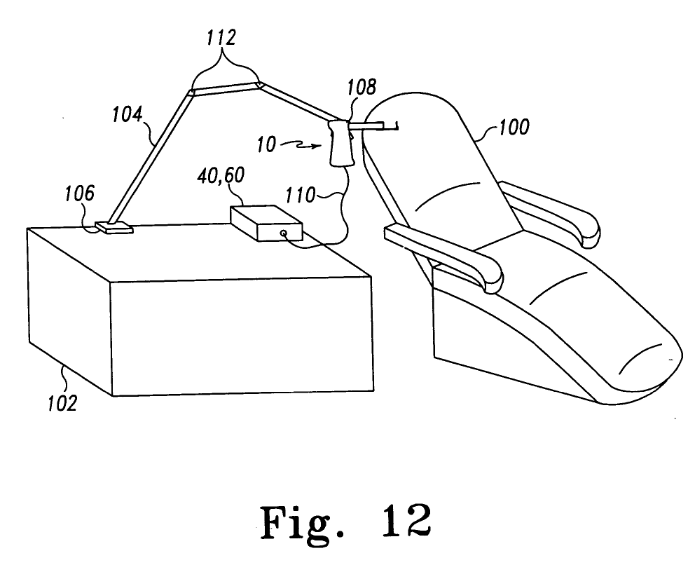

One of the advantages of the hand held X-ray device 10 of the present invention is that the hand held nature of the device allows not only ease of use by the X-ray technician, but also portability of the device from operatory to operatory. Such portability allows for a single hand-held X-ray unit 10 to be used in several different operatories, thereby greatly reducing the equipment and maintenance costs to the owner, such as a dentist, doctor, hospital, veterinarian, etc. Referring to FIG. 12, there is illustrated a first embodiment dental operatory which includes a portable X-ray device 10 of the present invention. A dental patient chair 100 is shown positioned next to a dental unit 102, which includes all of the tools and equipment needed by the dentist during a dental session. An articulating arm 104 is coupled to the dental unit 102 by means of a suitable connection 106. Alternatively, the articulating arm 104 may be freestanding and incorporate its own base (not shown). The distal end of the articulating arm 104 includes a cradle 108 which is adapted to releasably hold the portable X-ray unit 10. The power supply and control circuits 40, 60 of the X-ray unit are housed in an appropriate box which may be placed on or within the dental unit 102. A cable 110 couples the portable X-ray unit 10 to these circuits. The articulating arm 104 has a plurality of movable joints 112 which allow for adjustable positioning of the portable X-ray unit 10 in relation to the patient. A collection of operatories which share a portable X-ray unit 10 may be configured in several different ways. For example, each operatory may include its own articulating arm 104 and control circuitry 40, 60, while a single portable X-ray unit 10 and cable 110 is transported from operatory to operatory. The provision of the cradle 108 on the end of the articulating arm 104 provides for quick and convenient connection of the portable X-ray unit 10 into the equipment of the operatory. Alternatively, each operatory may be equipped with an articulating arm 104 and the control circuitry 40, 60 and portable X-ray generator 10 may be transported from operatory to operatory as a unit. This would further reduce the equipment costs experienced by the owner.

If an articulating arm 104 is utilized to hold the portable X-ray unit 10 during operation, a remote control firing mechanism may be used in place of the enable and fire switches 36 and 38 on the unit 10. Such remote control firing mechanism may be hard wired to the unit 10, or may be a wireless remote control utilizing infrared or low frequency RF signals. The use of such a remote control firing mechanism will allow the operator to leave the room prior to the generation of X-rays by the portable X-ray generator 10. Alternatively, the portable X-ray generator 10 may be utilized by the operator without leaving the room due to the greatly reduced X-ray dose which is generated by the X-ray generator 10. In this situation, the use of the articulating arm 104 will be optional, as the operator may simply hold the X-ray generator 10 in his or her hand during use. A further option is that the cable 110 may be integrated into the articulating arm 104 and terminate at a connector (not shown) within the cradle 108, such that the portable X-ray generator 10 may be coupled to the cradle 108 wherein the connector 34 of the portable X-ray generator 10 mates with the connector on the end of the cable 110. Such an arrangement will minimize the number of wires which are exposed at the dental unit 102.

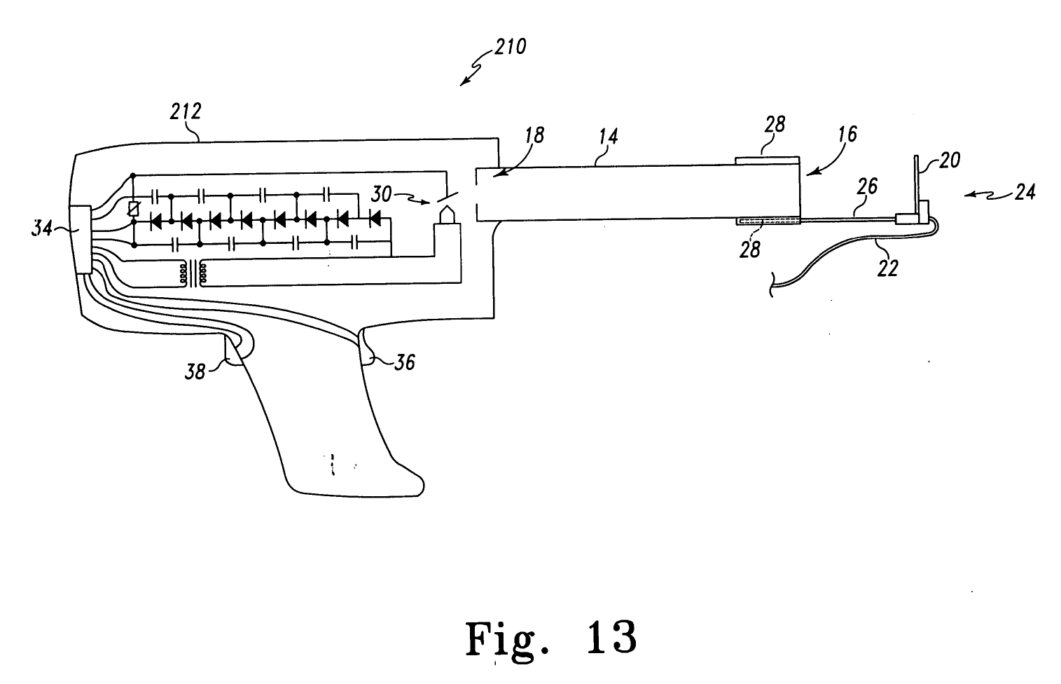

Referring now to FIG. 13, a second embodiment of the portable X-ray generator of the present invention is illustrated and indicated generally at 210. The X-ray generator 210 contains all of the same parts as the first embodiment X-ray generator 10, with the exception that the handle 212 is configured such that the electronic circuitry within the X-ray generator 210 is positioned above the portion of the handle 212 which is gripped by the user's hand. This enables the handle 212 to have a smaller gripping surface and to provide better balance to the X-ray generator 210.

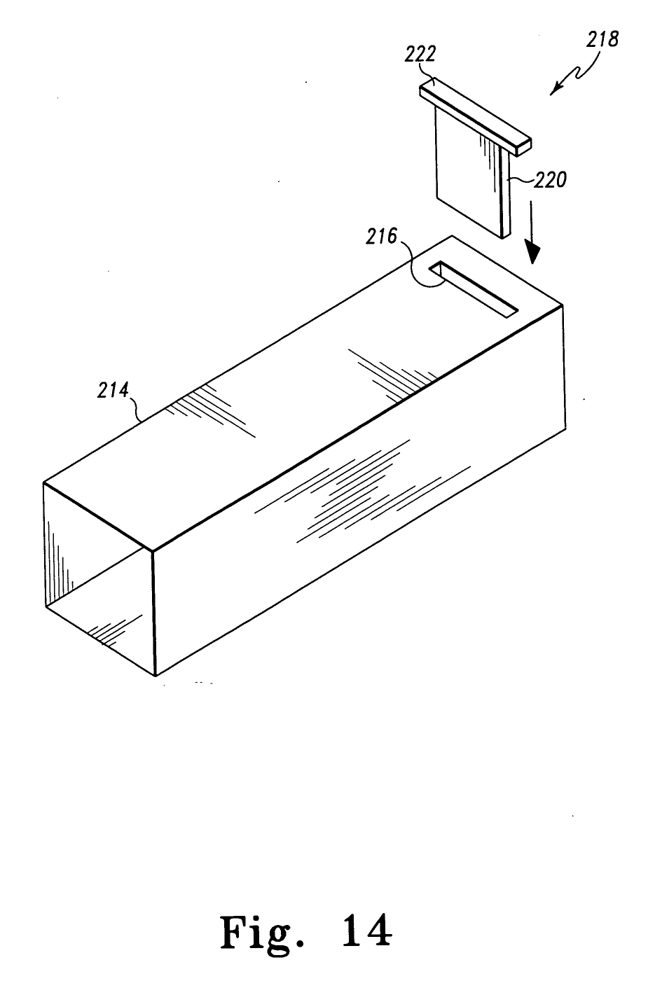

Referring now to FIG. 14, there is illustrated a second embodiment collimated tube 214 of the present invention. The collimated tube 214 is used to focus the X-ray beam in the same way as the collimated tube 14 discussed hereinabove. However, the collimated tube 214 includes a slot 216 in a top surface thereof which allows insertion of a filter 218 into the interior of the collimated tube 214, such that an X-ray beam passing through the collimated tube 214 must also pass through the filter 218, the filter 218 comprises a piece of material 220 adapted to modify an X-ray beam in any desired manner coupled to a holder 222 on one edge thereof. The filtering material 220 is sized so as to fit through the slot 216 in the collimated tube 214; however, the holder 222 is larger than the slot 216 and thereby maintains the positioning of the material 220 in the path of the X-ray beam.

As is known in the art, it is sometimes desirable to attenuate certain energy levels of the X-ray beam in order to heighten contrast when viewing cavities, bone change, etc. Different filter materials 220 may be used for achieving each of these different filtering functions. By providing for a drop-in filter 218 which may be easily inserted and removed from the slot 216 in the collimated tube 214, the present invention allows for quick and easy interchange of various filters to 18 when taking a series of X-ray images.

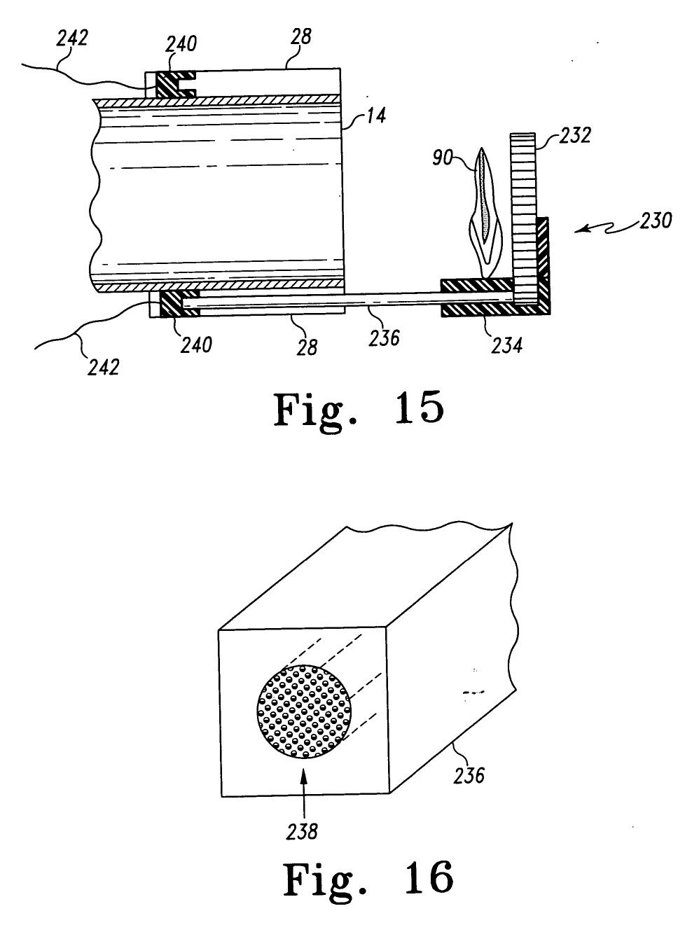

Referring now to FIG. 15, there is illustrated a side cross-sectional view of a third embodiment receptor holder of the present invention, indicated generally at 230. The receptor holder 230 includes an integral CCD receptor 232 that is permanently mounted to a plastic biteblock 234. A positioning bar 236 is used to couple the receptor holder 230 to the collimated tube 14 via the docking slots 28. Unlike the receptor holder 24 of FIG. 10, the CCD array 232 does not have a coupling wire 22 which hangs down from the receptor holder 230. Instead, the input and output ports of the CCD array 232 are coupled to an electronic communication path built into the rod 236, such as a multi-conductor wire or a fibre optic cable 238, as illustrated in FIG. 16. Each of the docking slots 28 incorporates an appropriate connector 240 at a proximal end thereof, wherein the connector 240 is designed to mate with the communication line 238 embedded within the rod 236. A second communication line 242 may then be routed to the appropriate data processing device which will store the image sensed by the CCD array 232. The communication lines 242 may be conveniently integrated into the structure of the collimated tube 14 and the handle of the X-ray device.

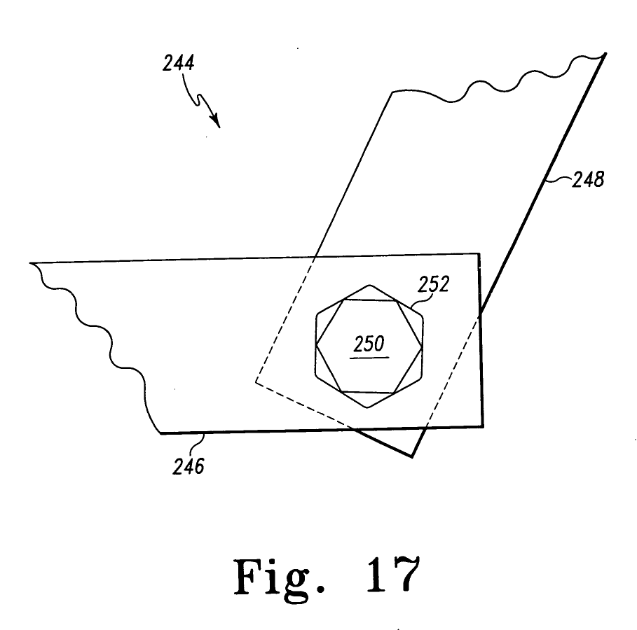

Referring now to FIG. 17, there is illustrated a fourth embodiment receptor holder of the present invention, indicated generally at 244. The receptor holder 244 includes a horizontal member 246 to which is coupled an X-ray receptor 248, such as X-ray film or a CCD sensor. The coupling between the receptor 248 and the horizontal member 248 is designed to allow the receptor 248 to be tilted at various angles with respect to the horizontal member 246. This allows flexibility of positioning the receptor holder 244 into a patient's mouth and ensures that the receptor 248 may be positioned at the desired location. The present invention comprehends the use of any coupling between the receptor 248 and the horizontal member 246 which will allow the receptor 248 to be tilted at various angles. One embodiment of such a coupling is illustrated in FIG. 17, and comprises a hexagonal protrusion 250 on either side of the receptor 248 which fits into a hexagonal recess or hole 252 on either side of the horizontal member 246 (the horizontal member 246 is bifurcated in order to allow room for the mounting and tilting of the receptor 248).

The dimensions of the hexagons 250 and 252 are chosen such that they exhibit an interference fit when in the position illustrated in FIG. 17. Such an interference fit will cause the receptor 248 to remain in the position shown unless enough force is applied thereto in order to move the hexagonal protrusion 250 past the interference with the hexagonal hole 252. This allows the receptor 248 to be adjusted in either direction, whereby it may be held at discrete angles. Those having ordinary skill in the art will appreciate that, although hexagons are illustrated in FIG. 17, protrusions and holes having any number of sides may be used to achieve the same effect with varying numbers of positions at which the receptor 248 may be held. Other means for allowing the receptor 248 to tilt with respect to the horizontal member 246 will be apparent to those having ordinary skill in the art.

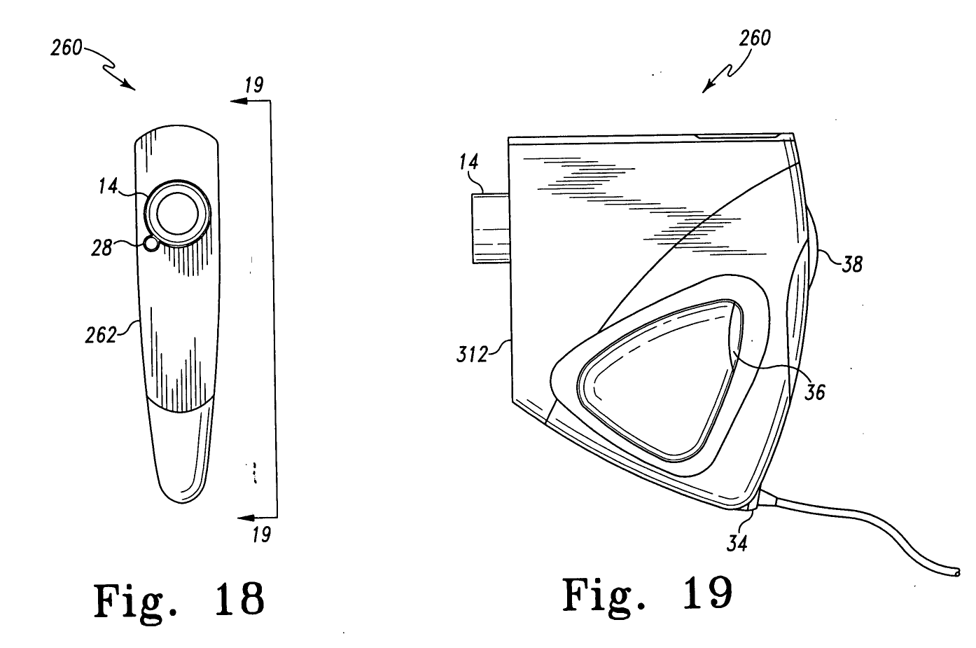

Referring now to FIGS. 18 and 19, there is illustrated a third embodiment portable X-ray generator of the present invention, indicated generally at 260. The X-ray generator 260 is functionally equivalent to the first and second embodiment X-ray generators 10, 110. However, the X-ray generator 260 has a different configuration for the handle 262. In the handle 262, most of the collimated tube 14 is incorporated within the interior of the handle 262. Inclusion of the collimated tube 14 within the handle 262 creates a more compact size for the X-ray generator 260. In all other respects, the X-ray generator 260 is functionally equivalent to the first and second embodiment devices, incorporating a docking slot 28, an enable switch 36, a fire switch 38, and an integral electrical connector 34 therein.

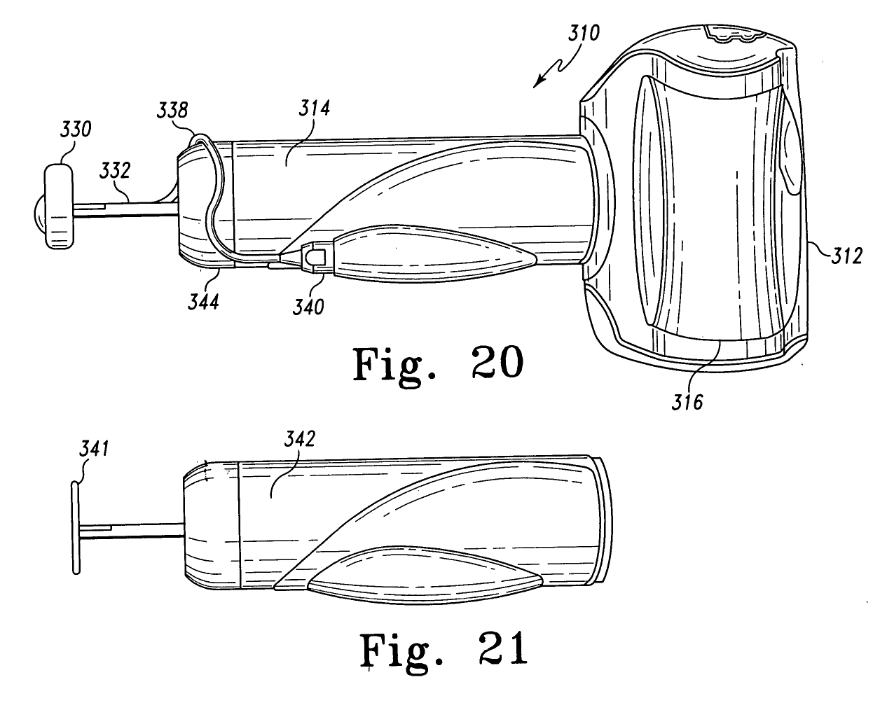

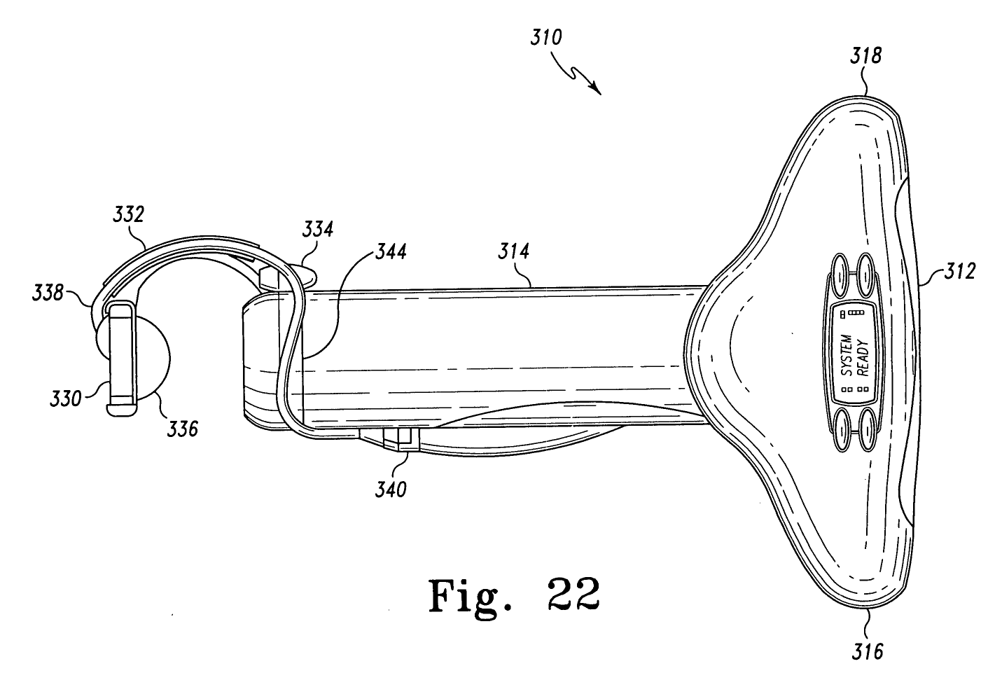

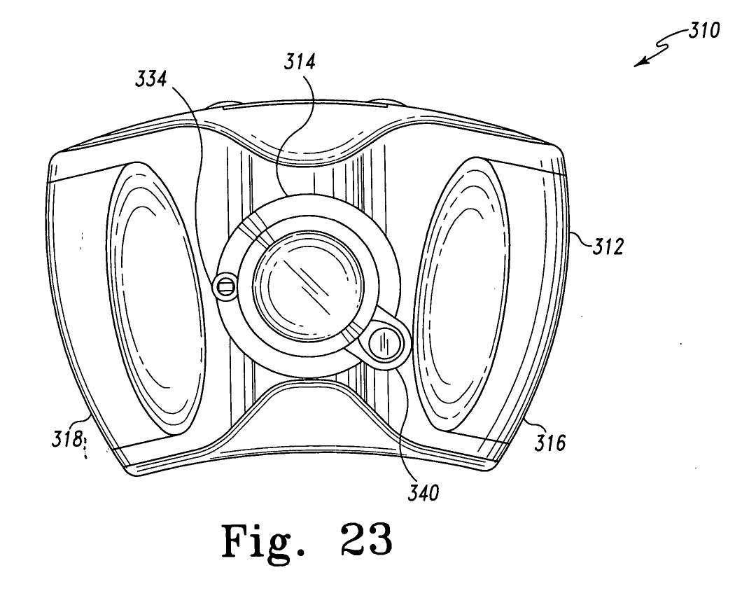

Referring now to FIGS. 20-24, there is illustrated a fourth embodiment portable X-ray generator of the present invention, indicated generally at 310. The X-ray generator 310 includes a handle 312 and collimated tube 314 attached thereto. The X-ray tube 314 preferably exhibits a round exterior surface, however, the interior of the X-ray tube 314 is preferably of a rectangular configuration having the same dimensions as the X-ray tube 14 described hereinabove.

The handle 312 of the X-ray generator 310 includes an X-ray tube 30 and associated driving circuitry 32 as described hereinabove. Because it is desired that the X-ray generator 310 comprise a portable and preferably hand-held X-ray generator, the isolation transformer normally used in X-ray generators has been eliminated in the present invention. Furthermore, the high-voltage transformer is not placed within the handle 312, but is remote from the X-ray generator 310, and the high-voltage signal is wired from the high-voltage transformer to the circuitry 32 within the handle 312, as explained in greater detail hereinabove. The handle 312 is filled with oil or preferably gas in order to dissipate heat generated by the X-ray tube 30, as is known in the art.

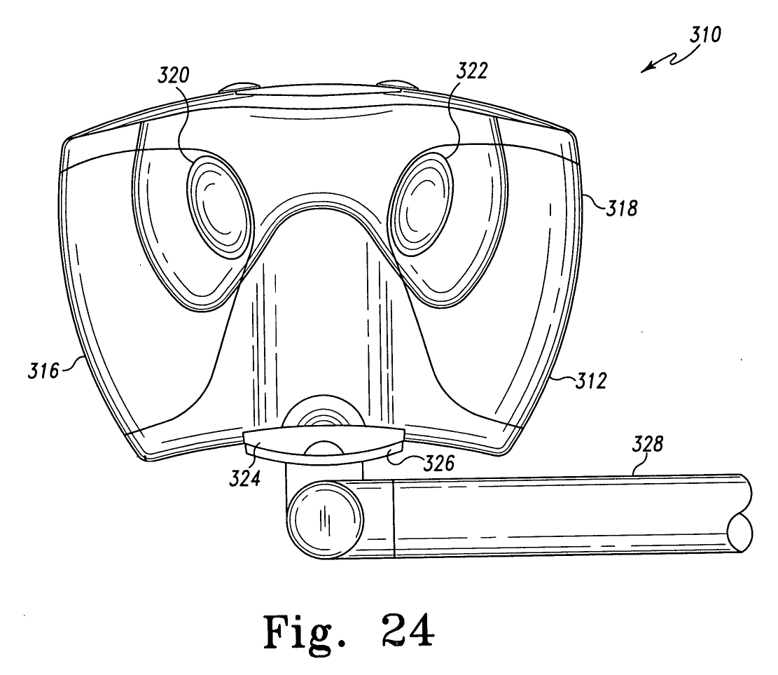

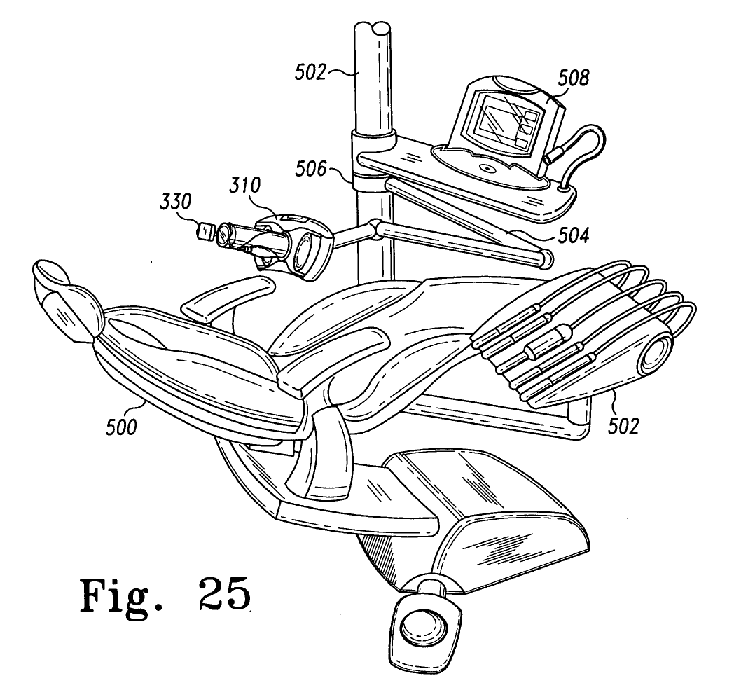

The handle 312 includes oppositely disposed left and right hand grips 316, 318 which are positioned to allow the user to grasp the X-ray generator 310 on opposite sides thereof. Gripping the handle 312 in this manner naturally places the user's left thumb over an enable switch 320, while the user's right thumb is positioned over a fire switch 322. As described in greater detail hereinabove, the enable switch 310 initiates current flow to warm up the X-ray tube 30 prior to actual firing of the X-ray generator 310. After the enable switch 320 has been depressed, the operator depresses the fire switch 322 in order to activate the X-ray generator 310. The two-switch configuration is intended to act as a safeguard against inadvertent firing of the unit. The switches 320, 322, as well as the other circuitry within the handle 312, are coupled to an electrical connector 324 formed into the rear of the handle 312. The connector 324 is shown attached to a mating connector 326 at the end of an articulating arm 328 in FIG. 24. This mounting arrangement is described in greater detail hereinbelow with respect to FIG. 25.

The portable X-ray generator 310 further includes a receptor 330, such as a CCD array, mounted to a receptor holder 332. The receptor holder 332 is, in turn, mounted to a docking slot 334 formed at the distal end of the X-ray tube 314. The receptor holder 332 includes an integral biteblock 336. A communications cable 338, which allows control and downloading of information from the CCD array 330, is coupled to an electrical connector 340 integrally formed with the X-ray tube 314. As is known in the art, some form of processor circuitry is necessary to control the operation of the CCD array 330 and to download image information therefrom. The communications between the CCD array 330 and this processor circuitry are routed over the conductor 338. Such processing circuitry may be housed within the handle 312 or may be located external to the portable X-ray generator 310. Therefore, the electrical connector 340 will couple these signals to a processor within the handle 312 if the processing circuitry is on-board. Otherwise, these signals will be coupled to the connector 324 if these processing functions are located outboard of the X-ray generator 310. Provision of the integral connector 340 allows the receptor holder 332 to be changed for repeated uses of the X-ray generator 310. Alternatively, the receptor holder could include an integral communications line, such as that illustrated in FIGS. 15-16, which would communicate with the processing circuitry through an electrical connector integral with the docking slot 334. In either scenario, reliable, repeatable connections may be made between various receptor connectors 332 and the portable X-ray generator 310 with a minimum amount of effort.

Alternatively, if it is desired to use the portable X-ray generator 310 only with X-ray film receptors, then it is not necessary to provide the electrical connector 340 on the X-ray tube 314. In such a situation, the X-ray tube 342 of FIG. 21 may be used instead, wherein the X-ray tube 342 is identical to the X-ray tube 314, except that it does not have any internal wiring terminating in a connector 340. The X-ray tube 342 therefore eliminates the expense of providing such electrical coupling. However, it will be appreciated by those having ordinary skill in the art that the X-ray tube 314 could also be used with an X-ray film receptor holder by simply not making any connection to the connector 340.

The docking slot 334 is mounted to the X-ray tube 314 on a rotatable ring 344 which allows the docking slot 334 to be rotated to the opposite side of the X-ray tube 314 in order to use the portable X-ray generator 310 on the opposite side of the patient's mouth.

One of the advantages of the portable X-ray generator 310 is that the hand-held nature of the device allows not only ease of use by the X-ray technician, but also portability of the device from operatory to operatory. Such portability allows for a single hand-held X-ray unit 310 to be used in several different operatories, thereby greatly reducing the equipment and maintenance costs to the owner, such as a dentist, doctor, hospital, veterinarian, etc. Referring to FIG. 25, there is illustrated a second embodiment dental operatory which includes a portable X-ray device 310 of the present invention. A dental patient chair 500 is shown positioned next to a dental unit 502. The dental unit 502 preferably comprises a floor-to-ceiling pole having mounting spaces for all of the tools and equipment needed by the dentist during a dental session. An articulating arm 504 is coupled to the dental unit 502 by means of a suitable connection 506, such as an adjustable diameter collar. Alternatively, the articulating arm 504 may be free-standing and incorporate its own base (not shown). The distal end of the articulating arm 504 includes means for attaching the portable X-ray unit 310 thereto, such as the electrical connector 326 (see FIG. 24). The articulating arm 504 is therefore adapted to releasably hold the portable X-ray unit 310. The power supply and control circuits 40, 60 of the X-ray unit are housed in a remote location, such as at the base of the dental unit 502. A cable within the articulating arm 504 couples the portable X-ray unit 310 to these circuits. The articulating arm 504 has a plurality of movable joints which allow for adjustable positioning of the portable X-ray unit 310 in relation to the patient.

In the embodiment illustrated in FIG. 25, the processing means for controlling the X-ray generator 310 and for downloading information from the CCD receptor 330 is in the form of a portable computer 508 which is coupled to the portable X-ray generator 310 via the cabling within the articulating arm 504 and the electrical connector 326. The computer 508 further includes a display screen for displaying image data captured by the CCD sensor 330. Control of the CCD sensor 330 by means of the computer 508 is well established in the prior art, therefore the details of this control are not described herein.

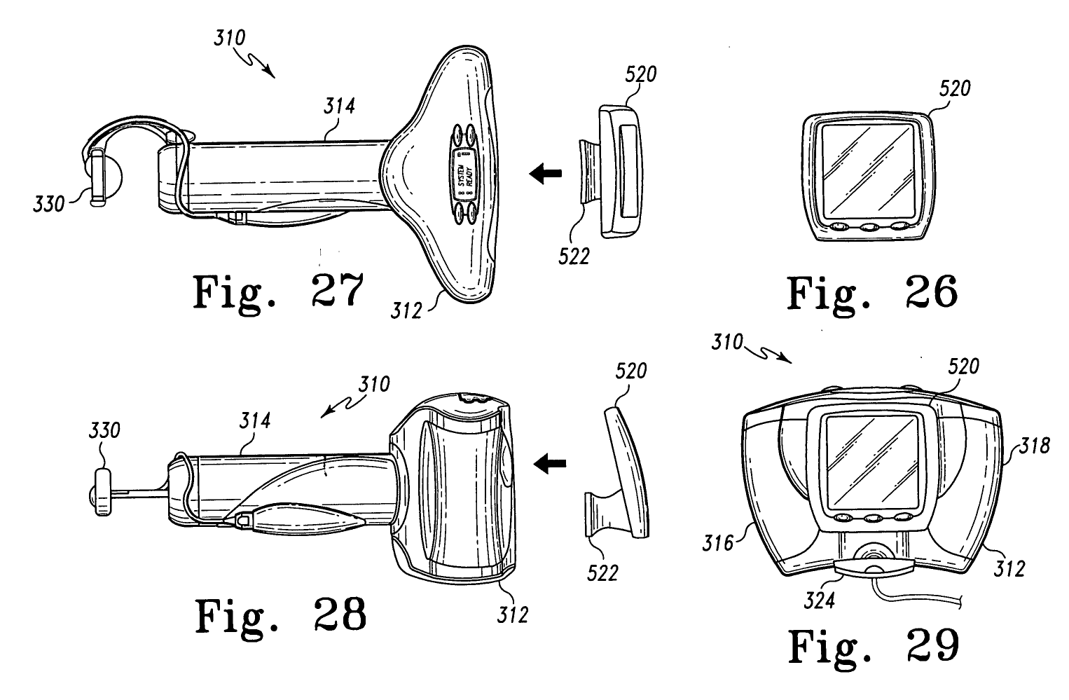

In the configuration illustrated in FIG. 25, the control of the portable X-ray generator 310 and CCD sensor 330 is provided by the computer 508. This therefore necessitates a coupling between the computer 508 and the portable X-ray generator 310 for use. However, this may not always be desirable, particularly in view of the portable nature of the X-ray generator 310. Therefore, the present invention comprehends incorporation of the processor control circuitry for the portable X-ray generator 310 into the handle 312 thereof. As illustrated in FIGS. 26-29, a display window 520 may be added to the rear face of the portable X-ray generator 310 in order to provide a display of the information sensed by the CCD sensor array 330. The processing circuitry for controlling the X-ray generator 310 and the CCD sensor array 330 may be contained within the display unit 520 or, alternatively, this processing circuitry may be within the handle 312, and the display window 520 may act solely as an input/output device. In either case, the display window 520 mounts to the handle 312 by an appropriate connector 522. The connector 522 provides not only a mechanical mounting for the display window 520, but also incorporates an appropriate electrical connector therein for providing communication between the display window 520 and the circuitry within the handle 312. By making the display window 520 removable from the portable X-ray generator 310, it can be made an optional attachment. Without the display window 520, the portable X-ray generator 310 may still be used in conjunction with an external controller such as the computer 508 of FIG. 25. If it is not desired to make the display window 520 optional, then it may be permanently mounted to the handle 312, foregoing the removable mechanical connection and removable electrical connection 522 therebetween.

In a preferred embodiment of the present invention, described in greater detail in the sections that follow, a personal digital assistant (PDA) device having a display is used to set exposure options and fire the X-ray device. Various types of PDA devices could be used, such as PDAs running Microsoft Windows CE, Microsoft Pocket PC, Palm, Symbian or other such operating systems, as a few nonlimiting examples. Any other PDA or handheld device as would occur to those of ordinary skill in the art could also be used. The PDA device is capable of working with the various embodiments of the X-ray device described herein. As one non-limiting example, the PDA device can serve as the remote control transmitter described herein to transmit enable and exposure signals to a receiver of the X-ray device. As another non-limiting example, the PDA device can be used instead of computer 508 to control the X-ray device. The PDA device can be coupled to the portable X-ray device, such as to the articulating arm or other part, can be used in a hand-held fashion, or can be coupled to another object separate from the X-ray device. The PDA device contains a program and/or database that allow a user to select options and control the X-ray device.

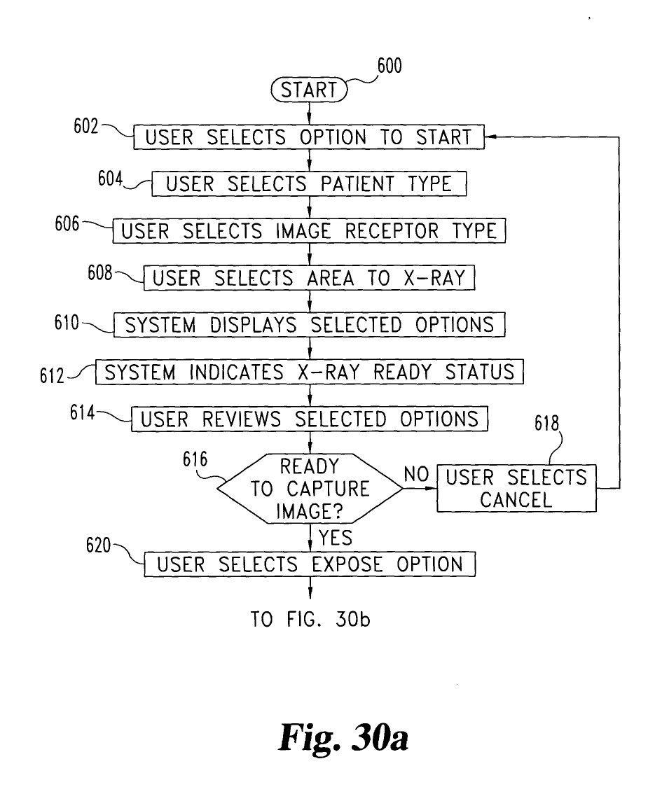

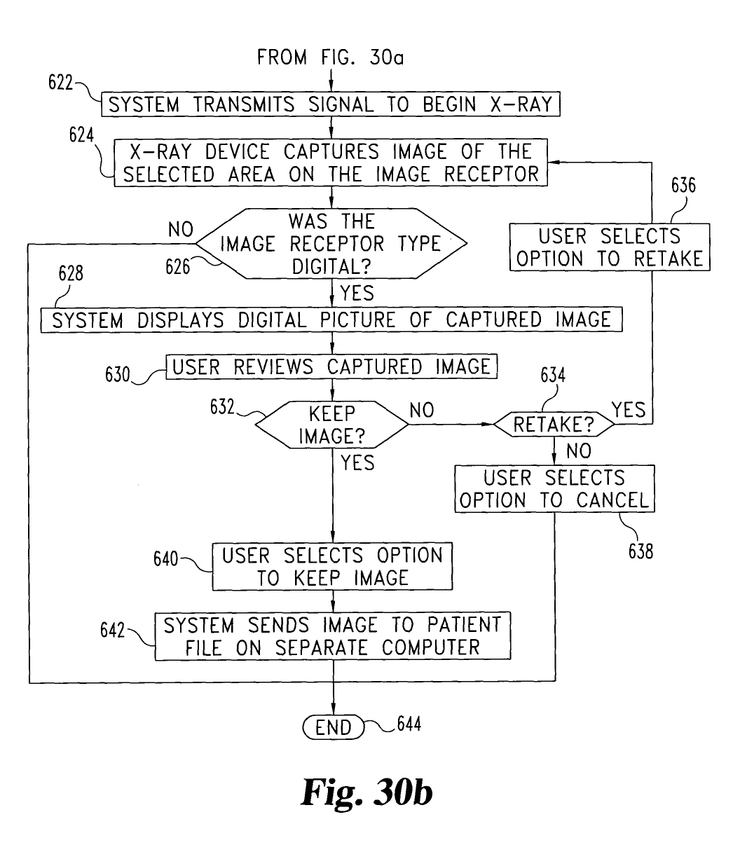

As shown in FIG. 30A, the first part 600 of a preferred embodiment process involves selecting exposure options to control an X-ray device using a PDA. The second part 624 of the process, as shown in FIG. 30B, involves controlling the X-ray device from the PDA and displaying a captured image on the PDA. Each part of the process will now be described with greater detail and with reference to the figures.

First, the process involving selecting exposure options for a portable X-ray device using a PDA shown in FIG. 30A will be discussed. The process starts at 600 and the user selects a start option 602. The user selects a patient type 604, an image receptor type 606, and an area or tooth to X-ray 608. The system displays the selected option 610 and also indicates whether the X-ray is ready to be fired 612. The user can review the selected options 614, and if ready to capture the image 616, can select the expose option 620. If either the user or X-ray are not ready to capture the images, the user can select the cancel option 618 and can optionally begin the process again.

Referring to FIG. 30B, if the user selects the expose option 620, a begin signal is transmitted from the PDA to the X-ray device 622. The begin signal can include an enable signal and an exposure signal as one non-limiting example. An image receptor receives X-rays emitted by the X-ray tube and captures an image 624. If the image receptor type was digital 626, such as a CCD device, then the system displays a digital picture of the captured image on the PDA 628. The user can review the captured digital image 630, and determine whether to keep the image 632, if the user decides to keep the image, the user selects an option on the PDA to keep the image 640. Upon selection of the keep option, the system sends the image to a database, such as the patient file, on a separate computer 642. If the user instead desires to retake the image 634, the user selects an option on the PDA to retake the image 636. The X-ray device then recaptures an image of the selected area on the image receptor 624. If the user does not want to keep the image 632, and does not want to retake the image 634, then the user can select an option to cancel 638. The image capture process then ends 644.

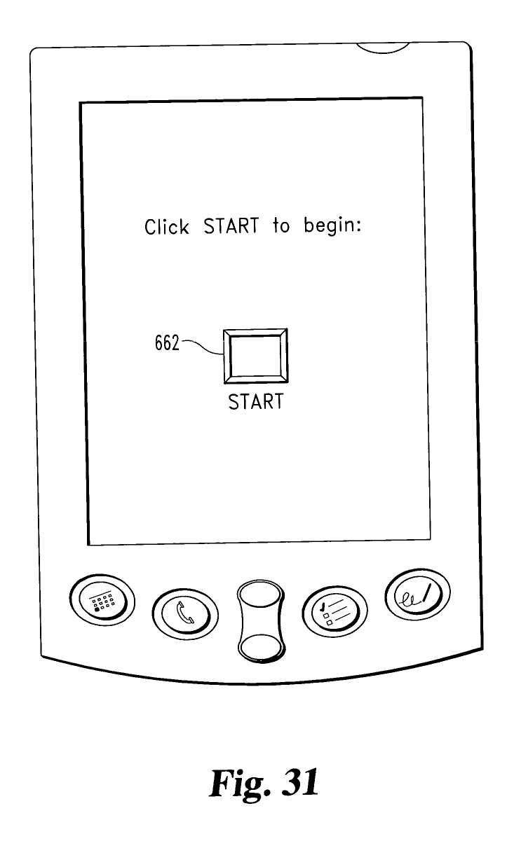

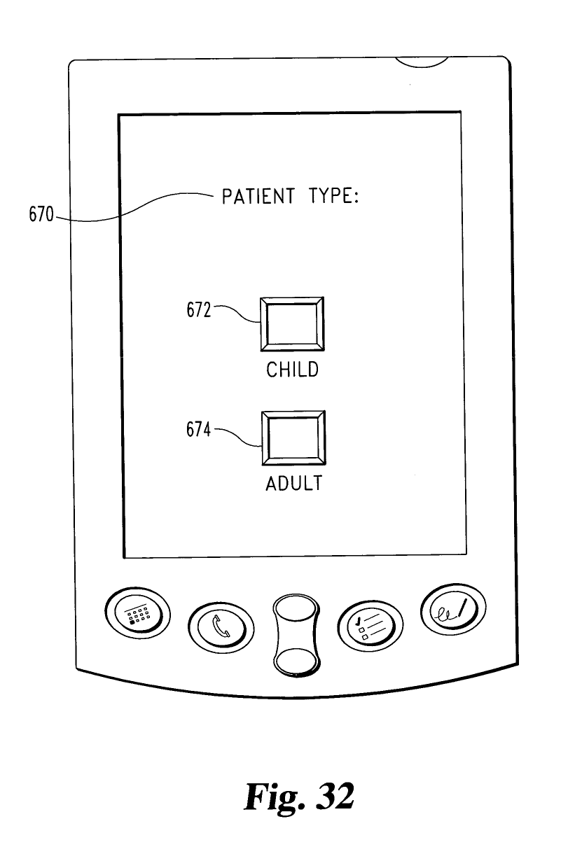

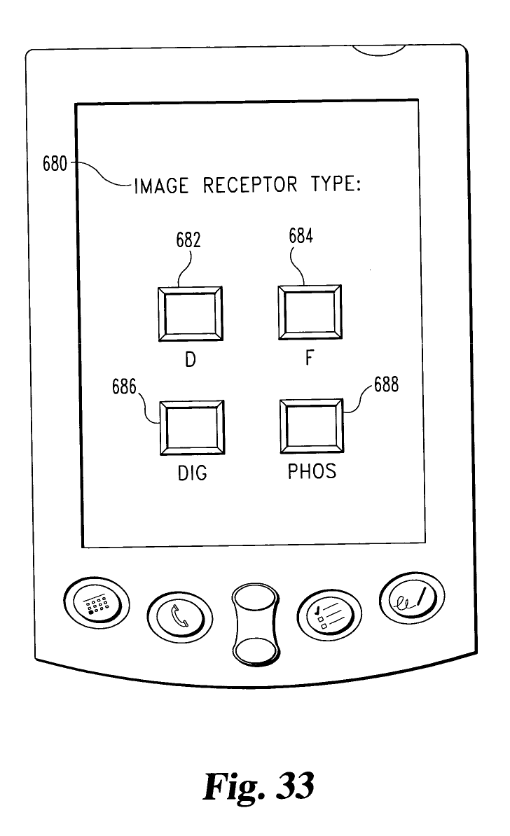

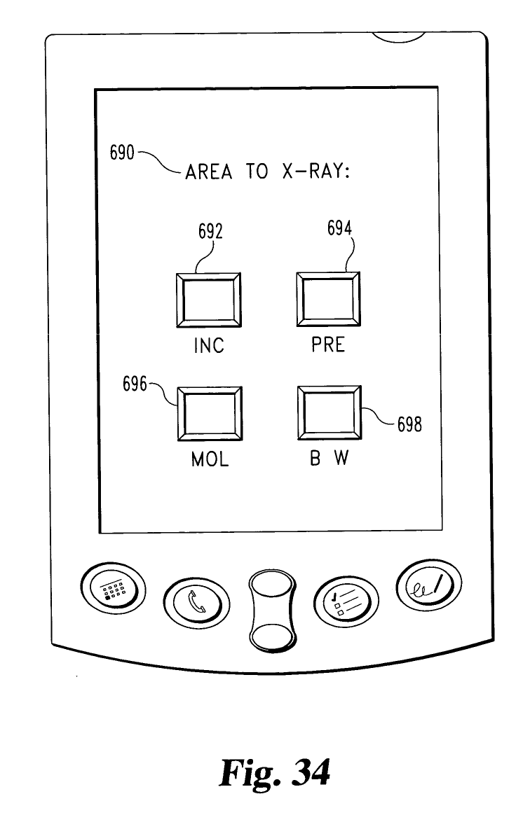

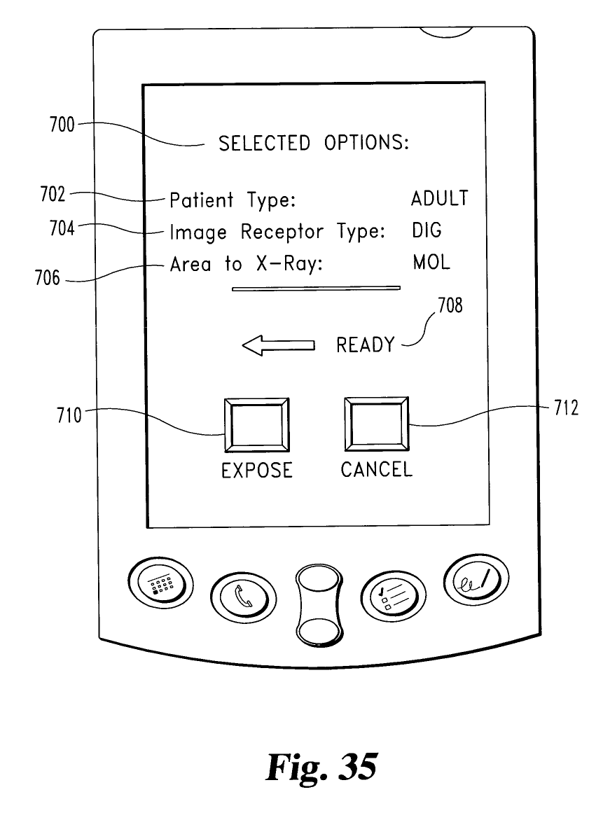

A preferred embodiment is illustrated in the following examples, with continuing reference to FIGS. 30A and 30B. First, as shown in FIG. 31, the user, such as the dentist or dental hygienist, selects a start option 662 on the PDA (stage 602). A screen as shown in FIG. 32 is then displayed with options for selecting a patient type 670. The user selects the type of patient being X-rayed (stage 604), such as by selecting the child option 672 or adult option 674. A screen as shown in FIG. 33 is then displayed with options for selecting an image receptor type 680. The user selects an image receptor type (stage 606), such as D 682 for D-speed film, F 684 for F-speed film, DIG 686 for digital solid-state detectors, PHOS 688 for phosphor plates. Those of ordinary skill in the art will appreciate the fact that other image receptors can also be used, and these are just a few non-limiting examples. A screen as shown in FIG. 34 is then displayed, indicating a list of areas that can be X-rayed 690. The user selects an area or tooth to X-ray (stage 608), such as an incisor 692, pre-molar 694, molar 696 or a bite wing 698. The pre-molar option is typically available only when adults are being X-rayed since children do not have pre-molars. The bite wing 698 option is typically selected when a user desires to capture both top and bottom teeth crown on one film to look for cavities. A confirmation screen as shown in FIG. 35 is then displayed to allow the user to review the selected options 700 (stage 610). The screen also indicates the X-ray ready status 708 (stage 612). When the ready indicator is displayed, the X-ray device is ready to be fired. The user reviews the selected options for patient type 702, image receptor type 704, and area to X-ray 706 (stage 614), and then decides whether to fire the X-ray. If after reviewing the selected options 700 and the X-ray ready status 708 the user decides not to proceed with the X-ray, the user selects the cancel 712 option (stage 618). If the X-ray device is ready and the user is ready to capture the image (stage 616), then the user selects the expose 710 option to begin the X-ray. After the user selects the expose 710 option (stage 620), the PDA device transmits a begin signal to begin the X-ray process (stage 622). The signal can be communicated by infrared, radio frequency, wireless Internet, or other wireless or wired communication means as would occur to one of ordinary skill in the art. As described in detail hereinabove, a collimated tube is positioned such that X-rays will be emitted into the collimated tube when the X-ray receives the begin signal, which in this example is received from the PDA device. The X-ray device then captures an image of the selected area on the image receptor (stage 624).

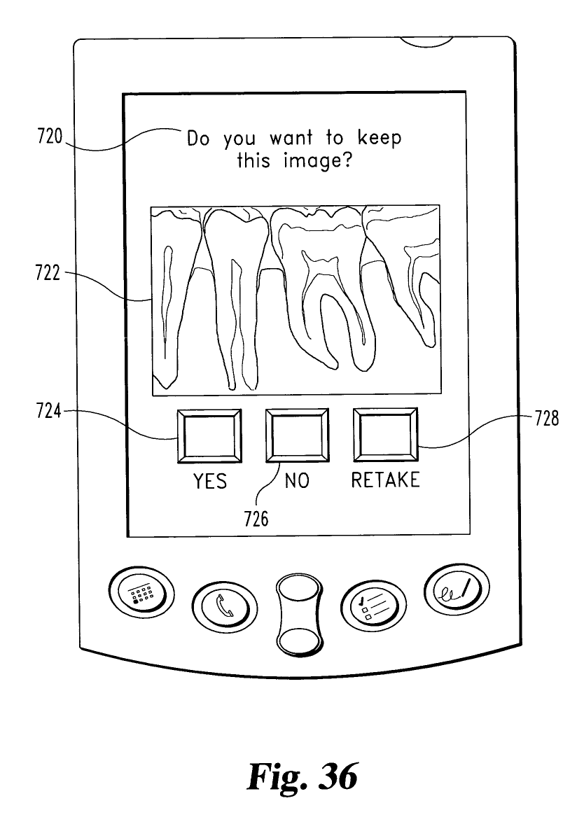

If the image receptor type is digital (stage 626), such as a CCD device, then a screen as shown in FIG. 36 is displayed. The system displays a digital picture 722 of the captured image (stage 628), and prompts the user to indicate whether or not to keep the image 720. Although the image 722 is shown as a black and white sketch for purposes of illustration, it is preferably a color image. If the user does not want to keep the image, the user can select an option to retake the image 728 (stage 634) or can select an option to cancel 726 (stage 638). If the user wishes to keep the image (stage 632), then the user selects the option to keep the image 724 (stage 640). The PDA then transmits the image to a database, such as a patient file, on a separate computer (stage 642). The image can be transmitted by various communication means, such as infrared, radio frequency, wireless Internet, or other wireless or wired communication means as would occur to one of ordinary skill in the art. Alternatively or additionally, the image can be stored on a removable storage device such as a Compact Flash™ card or memory stick for storage and/or later transfer to a computer or display device. The process then ends 644.

A person of ordinary skill in the computer software art will recognize that the user interface features, including the window navigation style, mechanism for selecting options, screen content, X-ray options and layouts could be organized differently to include fewer or additional options or features on the same screen or different screens than as portrayed in the illustrations and still be within the spirit of the invention.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1. A method for generating an X-ray image comprising:
providing a portable X-ray device;
providing a PDA device for selecting X-ray options;
transmitting a begin signal from the PDA device to the portable X-ray device; and
capturing an image on an image receptor upon receiving X-rays emitted by the X-ray device.

2. The method of claim 1, further comprising:
if the image receptor captured the image in a digital format, displaying a digital picture of the captured image on the PDA device.

3. The method of claim 2, further comprising:
selecting a save image option on the PDA device; and
transmitting the captured image to a database on a separate computer.

4. The method of claim 3, wherein the captured image is transmitted wirelessly from the PDA device to the separate computer.

5. The method of claim 1, wherein the begin signal is transmitted wirelessly from the PDA device to the portable X-ray device.

6. The method of claim 1, wherein the portable X-ray device comprises:
an enclosure;
an X-ray tube mounted within the enclosure;
a collimated tube mounted to the enclosure and positioned such that X-rays will be emitted into the collimated tube when the X-ray device receives a begin signal from the PDA device; and
wiring extending between an interior of the enclosure and an exterior of the enclosure and operative to couple an external power supply to the X-ray tube.

7. A method for generating an X-ray image comprising:
providing a portable X-ray device;
providing a PDA device for selecting X-ray options;
selecting one or more operational parameters on the PDA; transmitting a begin signal from the PDA device to the portable X-ray device,
said begin signal based on the selected one or more operational parameters; and
capturing an image on an image receptor upon receiving X-rays emitted by the X-ray device.

8. The method of claim 7, wherein one of the selected operational parameters is a patient type option.

9. The method of claim 7, wherein one of the selected operational parameters is an image receptor type option.

10. The method of claim 9, further comprising:
if the selected image receptor type option is digital, displaying a digital picture of the captured image on the PDA device.

11. The method of claim 10, further comprising:
selecting a save image option on the PDA device; and
transmitting the captured image to a database on a separate computer.

12. The method of claim 11, wherein the captured image is transmitted wirelessly from the PDA device to the separate computer.

13. The method of claim 7, wherein one of the selected operational parameters is an area to X-ray option.

14. The method of claim 7, wherein one of the selected operational parameters is an expose option.

15. The method of claim 7, wherein the begin signal is transmitted wirelessly from the PDA device to the portable X-ray device.

16. The method of claim 7, wherein the portable X-ray device comprises:
an enclosure;
an X-ray tube mounted within the enclosure;
a collimated tube mounted to the enclosure and positioned such that X-rays will be emitted into the collimated tube when the X-ray device receives a begin signal from the PDA device; and
wiring extending between an interior of the enclosure and an exterior of the enclosure and operative to couple an external power supply to the X-ray tube.

17. A method for generating an X-ray image comprising:
a) providing a portable X-ray device, comprising:
an enclosure;
an X-ray tube mounted within the enclosure;
a collimated tube mounted to the enclosure and positioned such that X-rays will be emitted into the collimated tube when the X-ray tube is activated;
wiring extending between an interior of the enclosure and operative to couple an external power supply to the X-ray tube;
power supply circuitry operative to generate a voltage to drive the X-ray tube, wherein the power supply circuitry is not contained within the enclosure and is coupled to the enclosure by the wiring;
control circuitry operative to control an exposure time of the X-ray tube, wherein the control circuitry is not contained within the enclosure and is coupled to the enclosure by the wiring;
a receiver coupled to the power supply and control circuitry, said receiver operable to receive wireless signals;
b) providing an articulating arm having a connector thereon, adapted to couple the X-ray device to the articulating arm;
c) coupling the X-ray device to the articulating arm;
d) aiming the collimated tube at an X-ray image receptor;
e) moving the articulated arm such that a structure to be imaged is positioned between the collimated tube and the receptor;
f) providing a PDA device having a display, said PDA device operable for wireless transmission of an enable signal and an exposure signal; and
g) selecting at least one option from the display of the PDA device, thereby causing the enable signal and the exposure signal to be wirelessly transmitted to the receiver.

18. The method of claim 17, wherein the control circuitry causes the power supply circuitry to generate the drive voltage when the exposure signal is received from the PDA device.

19. The method of claim 17, further comprising:
h) capturing an image on the image receptor after receiving the exposure signal from the PDA device.

20. The method of claim 19, further comprising:
i) displaying the captured image on the display of the PDA device.

21. The method of claim 20, further comprising:
j) providing an image save option on the display of the PDA device;
k) selecting the image save option; thereby causing the captured image to be transmitted to a separate computer for storage.

22. The method of claim 21, wherein the captured image is transmitted wirelessly from the PDA device to the separate computer and stored in a patient file on the separate computer.

23. A portable X-ray device comprising:
an enclosure;
an X-ray tube mounted within the enclosure;
a collimated tube mounted to the enclosure and positioned such that X-rays will be emitted into the collimated tube when the X-ray tube is activated;
wiring extending between an interior of the enclosure and operative to couple an external power supply to the X-ray tube;
power supply circuitry operative to generate a voltage to drive the X-ray tube, wherein the power supply circuitry is not contained within the enclosure and is coupled to the enclosure by the wiring;
control circuitry operative to control an exposure time of the X-ray tube, wherein the control circuitry is not contained within the enclosure and is coupled to the enclosure by the wiring;
a receiver coupled to the power supply and control circuitry, said receiver operable to receive wireless signals; and
a PDA device operable to wirelessly transmit an enable signal and an exposure signal to the receiver.

24. The portable X-ray device of claim 23 wherein the PDA device is mounted on an articulating arm, said articulating arm being releasably coupled to the enclosure.

25. An X-ray device, comprising:
an X-ray tube;
a collimated tube positioned such that X-rays will be emitted into the collimated
tube when the X-ray receives a begin signal from a PDA device;
a slot formed through a surface of the collimated tube; and
a filter removably inserted through the slot, such that an X-ray beam passing through the collimated tube will also pass through the filter.

26. The X-ray device of claim 25, wherein the begin signal is transmitted wirelessly from the PDA device to the X-ray device.
